(19) United States
(12) Patent Application Publication
(10) Pub. No.: US 2013/0292051 A1
(43) Pub. Date: Nov. 7, 2013

(54) METHOD AND APPARATUS FOR FABRICATING FIBERBOARD HONEYCOMB STRUCTURES

(71) Applicant: Alain Duron, Saint- Hyacinthe (CA)

(72) Inventor: Alain Duron, Saint- Hyacinthe (CA)

(21) Appl. No.: 13/979,643

(22) PCT Filed: Jan. 13, 2012
(86) PCT No.: PCT/CA12/00037

§ 371 Date: Jul. 12, 2013

(30) Foreign Application Priority Data
Jan. 13, 2011 (CA) 2,728,245

(51) Int. Cl. B32B 38/00

(52) U.S. Cl. CPC B32B 38/0004
USPC 156/257; 156/517

(57) ABSTRACT

A method and apparatus for the manufacture of shipping pallets from corrugated fiberboard or paperboard material. The sheets are fed into a die cutting assembly and scored, in pairs, on each alternating sheet of material, whereby a first score on a first sheet is scored facing upwardly, and another first score on a second sheet is scored facing downwardly, to provide a pattern. Adhesive is applied to the sheets at offset positions on Alternating sheets and the sheets are compressed to Facilitate bonding of the adhesive to the sheets.

This application claims priority from and hereby incorporates by reference Canadian Patent Application No. 2,728,245 filed Jan. 13, 2011.

The present invention relates to a method and apparatus for the manufacture of shipping pallets having an open-celled configuration, preferably of a honeycomb structure, which utilizes corrugated fiberboard or paperboard material and having cell panels which are easily formable into a desired shape and final dimension at an end user facility. This manufacturing process minimizes waste by permitting the imbrication pattern of various cut-outs on a single piece of the fiberboard or paperboard material while providing for an efficient expansion of the closed honeycomb cells to a hexagonal or similar pattern for the later assembly of a laminated panel. Further, the present invention relates to a foldable shipping pallet that can be shipped in its folded state to maximize the number of pallets shipped in a transport trailer and to reduce the space required to store the pallets at the end user's or distributor's facility.

### BACKGROUND OF THE INVENTION

Various methods have been used in the past to manufacture, in a continuous process, light weight fiberboard or paperboard having “honeycomb” shaped cell structures for transporting objects, as the honeycomb structure has been applied to various products requiring light weight filler and/or structural strength. The geometry of honeycomb structures can vary widely but the common feature of all such structures is an array of hollow cells separated by thin walls, the cells often being columnar and hexagonal in shape, and such fiberboard or paperboard having such “honeycomb” shaped cell structures allows for enough flexibility for easy expansion of the cellular structures of the fiberboard or paperboard, after the sheets are glued together at offset intervals, to create a hexagonal shape or the like. As such light weight fiberboard or paperboard is flexible, the range of appropriate dimensions of the open area of the cells forming the honeycomb shape is limited, and must remain small so as to offer a suitable compressive strength, 20 mm being generally the maximum diagonal width of a cell manufactured for panel which is nevertheless very weak.

However, producing such a small diameter cell requires a large amount of paperboard. The current practice to manufacture a paperboard or manocque pallet is to mechanically remove the material, and, with current manufacturing methods, this requires an additional operation. Furthermore, there is a fair amount of waste generated, as the cell is manufactured from rolls of paper of a given width that will produce an equivalent width of continuous cell that generally cannot be trimmed to the required precise width needed. As a matter of normal practice, it will usually instead be expanded and then laminated with a covering top and bottom paperboard which is then trimmed to the required dimensions, consequently generating large volumes of waste material with very little flexibility for optimization of the process.

One method to attempt to counter the above-noted problems is disclosed in U.S. Pat. No. 4,498,445 (Hees). Hees Discloses sheets of corrugated paperboard that are fed to a die cutter that slits an array of linear cuts on the paperboard, interrupted at equal intervals by short uncut portions and creating, with the same die apparatus, an array of perpendicular creases or short perforated slit-score crease rows. The uncut portions of the slits permit the integrity of the sheet to be maintained so that glue spots can be further applied in precise locutions on the sheet. After the sheets are glued to one another in a staggered row and the glue it cured, the remaining uncut portions of the sheets are sheared off in a subsequent operation. However, this method presents several shortcomings. Firstly, this method weakens the honeycomb structure used for pallet construction, as the staggered cut and uncut patterns are very weak where the forklift openings are created. Secondly., the uncut portions of the sheets require a subsequent, additional shearing operation and then a further sanding operation to make the surface even. Thirdly, the process does not permit the opportunity to manufacture pre-shaped honeycomb shapes in anything other then rectangular or square shapes. In addition, the creases applied to the sheet in the die cut process are not sufficient to easily permit expansion into hexagonal shaped cells up to 70 mm diagonal width, as opposed to creating a mechanically applied fold to the sheet. With a smaller diagonal width of the cell, such as 20 mm, an extreme pulling force needs to be applied to the cell panel in order to expand it to a hexagonal or similar shape. As such, it is not uncommon that the force required to expand the cell in these situations exceeds that of the bond of the corrugated paperboard panels, which results in a delamination of the paperboard rather than expansion of the paperboard into a cell. However, if the cell was to be of a greater width, such as up to 70 mm diagonal width, a significantly reduced pulling force is required for cell formation.

It would therefore be advantageous to provide a manufacturing process for shipping pallets of fiberboard or paperboard material having an open-celled configuration, preferably of a honeycomb structure, which can be easily expanded into shaped cells as large as up to 70 mm diagonal width, but without the disadvantages noted above for larger cells, in particular the problems of providing adequate compressive strength.

It would be further advantageous to have a manufacturing process able to manufacture shipping pallets of fiberboard or paperboard material having formed honeycomb shaped cells that are operably able to be pre-cut to a shipping pallet profile.

It would be still further advantageous to provide an Inexpensive, foldable shipping pallet that can be shipped in its folded state to maximize the number of pallets which can be shipped in a transport trailer and to reduce the space required to store the pallets at the end user's or distributor's facility. To this end, the present invention effectively addresses these needs.

### SUMMARY OF THE INVENTION

The present invention provides an improved manufacturing process for shipping pallets of fiberboard or paperboard material having an open-celled configuration, preferably of a honeycomb structure, which can be easily expanded into shaped cells as small as 70 mm diagonal width or less.

The present invention also provides an improved Manufacturing process able to manufacture shipping pallets of fiberboard or paperboard material having formed honeycomb shaped cells that are operably able to be pre-cut to a shipping pallet profile.

In addition, the present invention further provides an Improved inexpensive, foldable shipping pallet of Fiberboard or paperboard material having an open-celled configuration, preferably of a honeycomb structure, which can be easily expanded into shaped cells as small as 70 mm diagonal width or less, and which can be shipped in its folded state to maximize the number of pallets shipped in a transport trailer and to reduce the space required to store the pallets at the end user's facility.

According to a first broad aspect of an embodiment of the present invention, there is disclosed a method of forming an unfolded cellular pallet structure from sheets of fiberboard or paperboard material comprising loading sheets of the fiberboard or paperboard material into a die cutting assembly; scoring each of the sheets, the scoring being effected in pairs on each alternating sheet of material, whereby a first score on a first sheet is scored facing upwardly, and another first score on a second sheet is scored facing downwardly, to provide a pattern; applying a first application of cold adhesive to each of the sheets; applying a second application of adhesive to each of the sheets, the second application of adhesive being applied at offset positions to the first application of adhesive on alternating sheets; compressing the sheets to facilitate bonding of the adhesive to the sheets; and applying a third application of adhesive on the sheets, the third application of adhesive being positioned so as to substantially correspond to a positioning of the first application of adhesive.

According to a second broad aspect of an embodiment of the present invention, there is disclosed a method of manufacturing an unfolded cellular pallet structure from sheets of fiberboard or paperboard material comprising loading sheets of the fiberboard or paperboard material into a die cutting assembly; scoring each of the sheets between a pair of rotating gears, the scoring being effected in pairs on each alternating sheet of material, whereby a first score on a first sheet is scored facing upwardly, and another score on a second sheet is scored facing downwardly, to provide a hexagonal pattern; applying a first application of adhesive to each of the sheets; applying a second application of adhesive to each of the sheets, the second application of adhesive being applied at offset positions to the first application of adhesive on alternating sheets; compressing the sheets to facilitate bonding of the adhesive to the sheets; applying a third application of adhesive on the sheets, the third application of adhesive being positioned so as to substantially correspond to a positioning of the first application of adhesive; applying pressure sensitive adhesive to top and bottom surfaces of the unexpanded sheets; covering the top and bottom surfaces of the unexpanded sheets with a release liner; and shipping the unfolded cellular pallet structure to a remote facility for later unfolding of the pallet structure.

According to a third broad aspect of an embodiment of the present invention, there is disclosed a method of manufacturing an unfolded cellular pallet structure from sheets of fiberboard or paperboard material comprising loading sheets of the fiberboard or paperboard material into a die cutting assembly; scoring each of the sheets between a pair of rotating gears, the scoring being effected in pairs on each alternating sheet of material, whereby a first score on a first sheet is scored facing upwardly, and another score on a first sheet is scored facing downwardly, to provide a hexagonal pattern; applying suction to the sheets to permit connection to a flat cut die of the die cutting assembly; applying a first application of adhesive to each of the sheets; applying a second application of adhesive to each of the sheets, the second application of adhesive being applied at offset positions to the first application of adhesive on alternating sheets; compressing the sheets to facilitate bonding of the adhesive to the sheets; applying a third application of adhesive on the sheets, the third application of adhesive being positioned so as to substantially correspond to a positioning of the first application of adhesive; applying cold adhesive to top and bottom surfaces of the unexpanded sheets; expanding cells of the unfolded cellular pallet structure into shaped cells between 25 and 70 mm width; covering the top and bottom surfaces of the unexpended sheets with a liner.

According to a fourth broad aspect of an embodiment of the present invention, there is disclosed a method of manufacturing an unfolded cellular pallet structure from sheets of fiberboard or paperboard material comprising loading sheets of the fiberboard or paperboard material into a die cutting assembly; scoring each of the sheets between a pair of rotating gears, the scoring being effected in pairs on each alternating sheet of material, whereby a first score on a first sheet is scored facing upwardly, and another first score on a second sheet is scored facing downwardly, to provide a hexagonal pattern; applying suction to the sheets to permit connection to a flat cut die of the die cutting assembly; applying a first application of adhesive to a first one of the sheets; ejecting the first one of the sheets onto an accumulating platform; applying a second application of adhesive to the first one of the sheets; ejecting at least a second one of the sheets onto an accumulating platform; applying a first application of adhesive to the at least a second one of the sheets; ejecting the at least a second one of the sheets; applying a second application of adhesive to the at least a second one of the sheets, the second application of adhesive being applied at offset positions to the first application of adhesive applied on the first one of the sheets, and so forth; compressing the sheets to facilitate bonding of the adhesive to the sheets; applying cold adhesive to top and bottom surfaces of the unexpanded sheets; expanding cells of the unfolded cellular pallet structure into shaped cells between 25 and mm width; covering the top and bottom surfaces of the unexpanded sheets with a release paper.

According to a fifth broad aspect of an embodiment of the present invention, there is disclosed an apparatus for manufacturing an unfolded cellular pallet structure from sheets of fiberboard or paperboard material comprising a feeder for feeding the sheets into the apparatus; a pair of rotating gears for receiving the sheets from the feeder and scoring each of the sheets therebetween; a flat cutting die assembly for receiving the sheets from the pair of rotating gears; vacuum means positioned on the flat cutting die assembly for applying suction to the sheets to permit connection to the flat cutting die assembly; an adhesive applicator positioned on the flat cutting die assembly for applying adhesive to each of the sheets; and a pair of rollers for compressing each of the sheets to facilitate bonding of the adhesive to the sheets.

### BRIEF DESCRIPTION OF THE DRAWINGS

The embodiments of the present invention will now be described by reference to the following figures, in which identical reference numerals in different figures indicate identical elements and in which:

FIG. 1 is a perspective view of an embodiment of the automated single sheet feeder for the apparatus of the present invention;

FIG. 2 is a partial view of an embodiment of the sheet positioning and elevating platform of the present invention;

FIG. 3 is a partial view of an embodiment of the flat cutting die of the present invention;

FIG. 4 is a partial view of the embodiment of the flat cutting doe of the present invention shown in FIG. 3, and which illustrates the anvil roller and the vacuum cups thereon;

FIG. 5 is a partial view of an embodiment of the compression deck of the present invention being shown in an uncompressed state;

FIG. 6 is a partial view of an embodiment of the compression deck of the present invention shown during compression of the stack of sheets;

FIG. 7 is a partial view of an embodiment of the cell blocs pressing table of the present invention;

FIG. 8 is a partial view of an embodiment of the motorized grip rollers of the present invention;

FIG. 9 is a partial view of an embodiment of the lateral guides and compression conveyor of the present invention;

FIG. 10 is a partial view of an embodiment of the rotating gears of the present invention;

FIG. 11 is a partial view of an embodiment of the stack of sheets during application of the cold adhesive; and

FIG. 12 is an exploded view of a further embodiment of the flat cutting die of the present invention, and which illustrates the hollow core of the flat cutting die for facilitating the air flow thereon to improve the suction capabilities of the die.

### DETAILED DESCRIPTION OF THE INVENTION

The invention will be described for the purposes of illustration only in connection with certain embodiments; however, it is to be understood that other objects and advantages of the present invention will be made apparent by the following description of the drawings according to the present invention. While a preferred embodiment is disclosed, this is not intended to be limiting. Rather, the general principles set forth herein are considered to be merely illustrative of the scope of the present invention and it is to be further understood that numerous changes may be made without straying from the scope of the present invention.

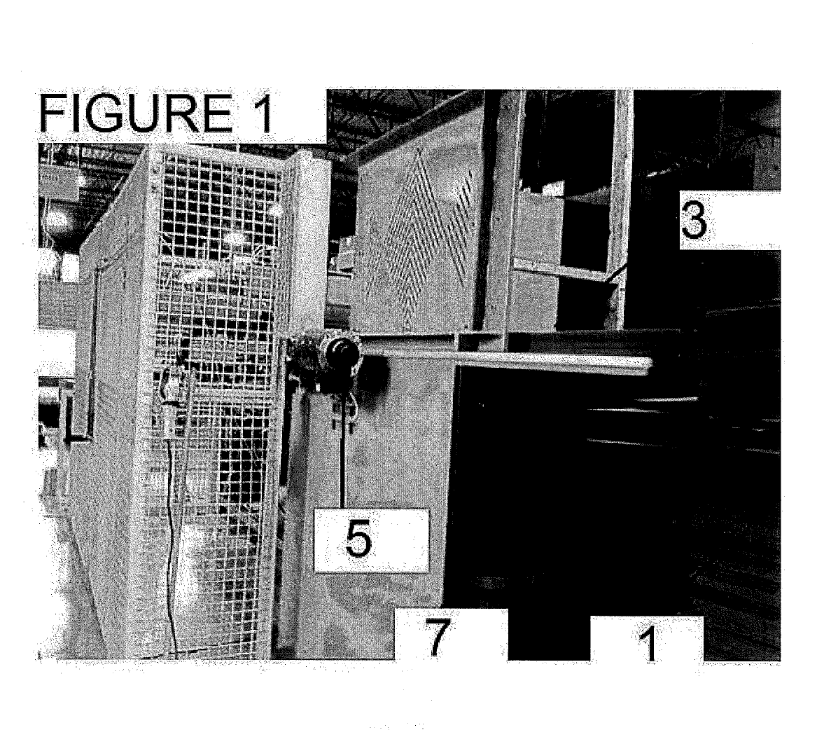

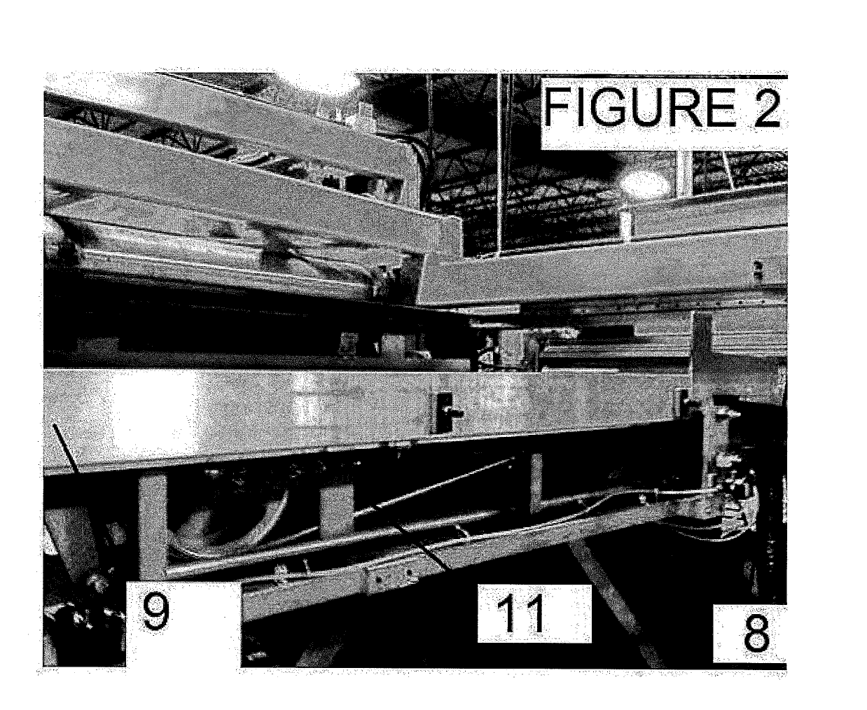

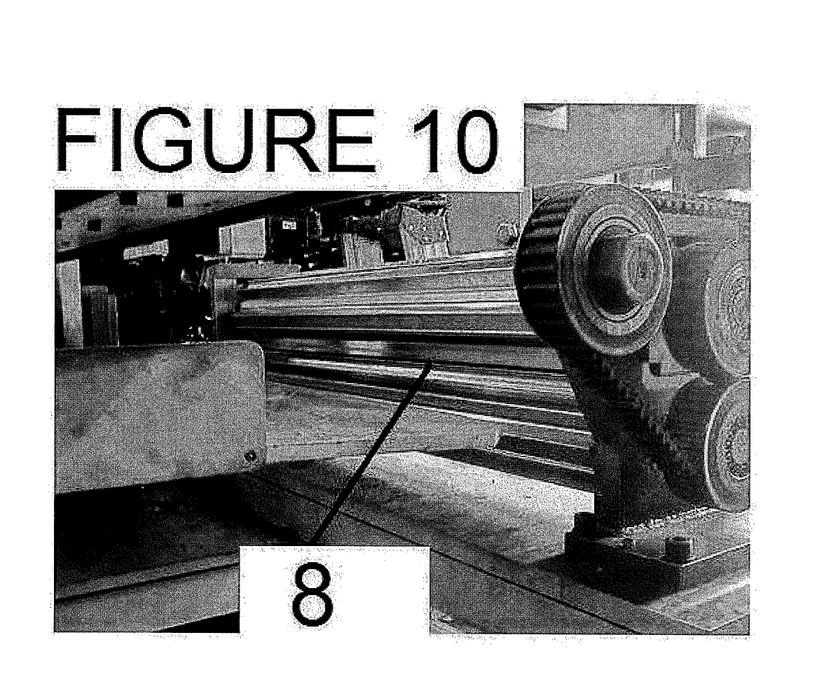

Referring to FIG. 1, a first exemplary embodiment of the method and apparatus for the manufacture of shipping pallets of the present invention is shown. As discussed previously, shipping pallets of corrugated fiberboard or paperboard material having an open-celled configuration, are used to form honeycomb shaped cells that are pre-cut to a shipping pallet profile. With reference to FIG. 1. a pile of fiberboard or paperboard sheets is loaded onto an automated single sheet feeder 3, the sheets being driven by a urethane covered roller (not shown) that feeds individual sheets, the roller being driven by a motor 5. In a preferred embodiment, the sheets are fed individually between a set of driven rotating gears 8, as shown in FIG. 10, that score/fold the sheets at one inch intervals to create a two (2) inch diagonal width hexagonal cell, as seen in FIG. 2. In a preferred embodiment, the scores are effected on the sheets in pairs of alternating upwardly facing and downwardly facing scores. For example, the first score on the first sheet will be facing upwardly, and the scores effected as the next sheet will be facing downwardly and so on, with a view to providing for laminated sheets for forming a hexagonal pattern when later expanded, as hereinafter described.

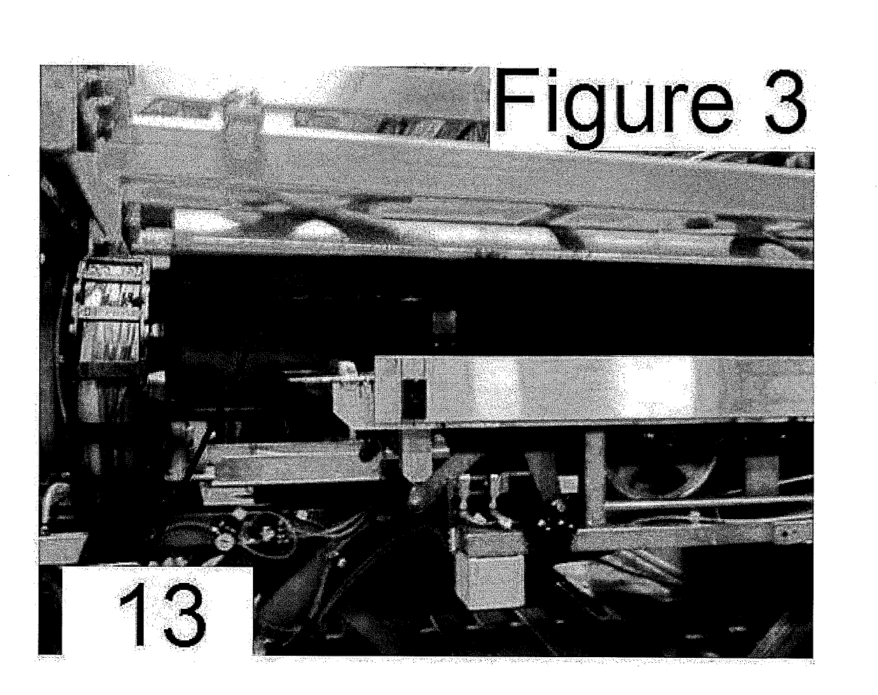

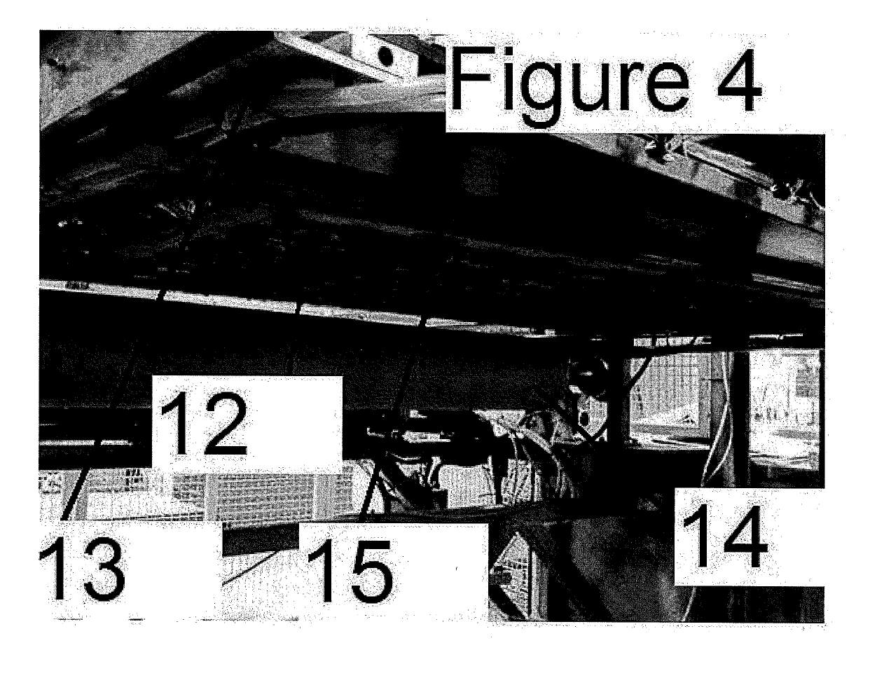

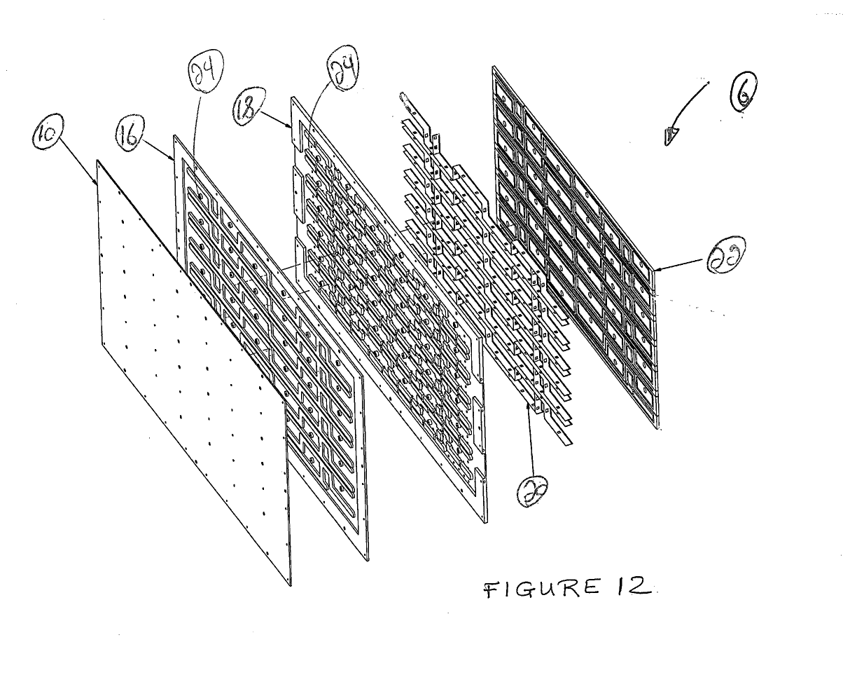

Once scored, the sheets are then conveyed onto a sheet positioning and elevating platform 9, as seen in FIG. 2, that elevates the sheets and feeds them, using conveyor rubber belts 11 inserted within the sheet positioning and elevating platform 9, to a flat cutting die assembly 13, as shown in FIGS. 3, 4 and 12, and then that moves the sheet towards the stopper bloc, as hereinafter described. In a preferred embodiment, as shown in FIGS. 3 and 4, the flat cutting die assembly 13 contains vacuum cups 15 which are provided with suction by a high velocity vacuum means 7 (shown in FIG. 1) that holds the sheets stable, and the flat cutting die assembly 13 moves forward to cover the sheet 1. The vacuum cups 15 then secure and hold the sheet 1 onto the flat cutting die assembly 13. Once the vacuum cups 15 have engaged the sheet 1, the sheet positioning and elevating platform 9 returns to its lower position. With further reference to FIG. 12, there is shown an exemplary embodiment 6 of the flat cutting die assembly 13, and illustrates an exploded view of the flat cutting die 13, and which also illustrates the hollow core of the flat cutting die 13 for facilitating the air flow thereon to improve the suction capabilities of the die. More particularly, there is shown an upper layer 10, upper intermediate layer 16, middle layer 18, lower intermediate layer 20 and lower layer 22 which are interconnected through conventional means, though it will be understood that the number of layers could be varied. In doing so, these form a substantially hollow core by virtue of ridged channels 24 therein, which permit air to flow therebetween, which improves the suction capabilities of the die suction when the suction is applied.

With reference to FIG. 4, the flat cutting die assembly 13 that holds the sheet 1 then travels through a pair of rollers; a drive roller (not shown) and an anvil roller 14. It will be understood that the rotating gears 8 serve only to score and break the sheets at the desired locutions. With reference to FIG. 4, the cutting action of the sheets is then performed by the cutting knives 12 of the flat cutting die assembly 13 (as the sheet is held in place to the die by vacuum cups 15) and the flat cutting die assembly 13 travels between the drive roller (not shown) and the anvil roller 14. The anvil roller 14 allows for the knives 12 to cut through the sheets and enter slightly into the resilient anvil roller 14 to create a cut. The flat cutting die 13 has strips of rubber all along both sides of the knives 12 that later provide for easy ejection of the sheets from the flat cutting die assembly 13, the ejection of the sheets by forced by the application of reversed forced air from the vacuum means 7 and precisely piled into a straight stack, as hereinafter described.

In a further embodiment, the flat cutting die assembly 13 can further comprise glue bead applications, which are preferably mounted on a front portion of the cutting die assembly 13 and which spray beads of adhesive onto the sheets as the flat cutting die assembly 13 travels back and forth. In a preferred embodiment, the glue bead applicators are horizontally spaced apart and apply sixteen beads of liquid adhesive in two different positions on each sheet, though it will be understood that the number of glue bead applicators could be varied. As the glue bead applicators are mounted onto the flat cutting die assembly 13, they travel with it and apply adhesive in each of the forward and reverse motions of the flat cutting die assembly 13.

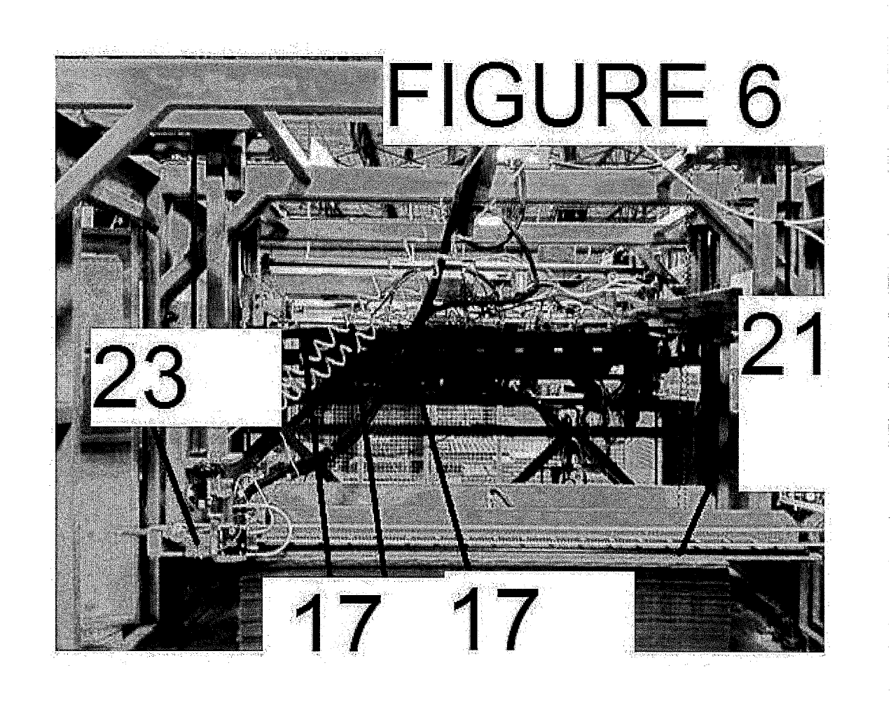

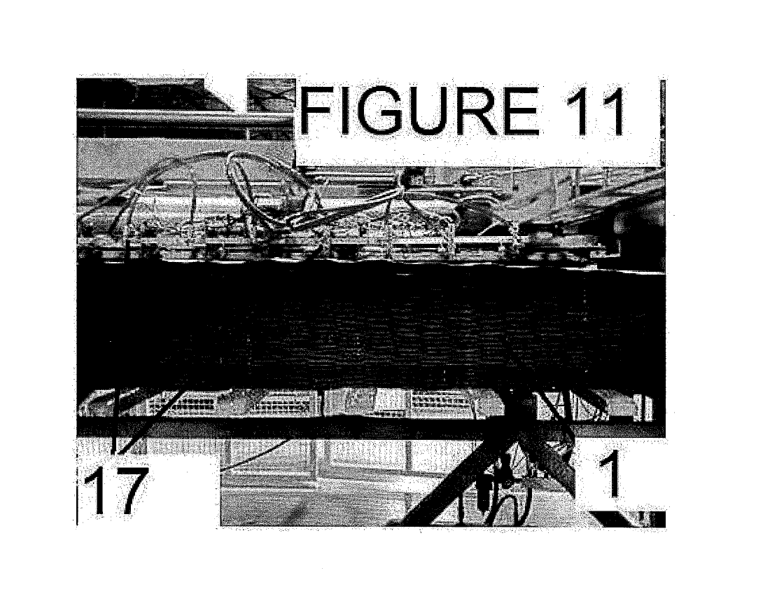

With reference to FIGS. 6 and 11, in an alternative embodiment, the flat cutting die assembly 13 can further comprise cold glue bead applicators 17, which are preferably mounted on a front portion of the cutting die assembly 13 and which place the beads of adhesive onto the sheets as the flat cutting die assembly 13 travels back and forth. In a preferred embodiment, the cold glue bead applicators 17 are horizontally spaced apart according to the width of the hexagonal cell to be made and comprises eight high speed guns that apply sixteen beads of cold liquid adhesive is two different positions on each sheet, as hereinafter described, though it will be understood that the number of cold glue bead applicators 17 could be varied. As the cold glue bead applicators 17 are mounted onto the flat cutting die assembly 13, they travel with it and apply adhesive in each of the forward and reverse motions of the flat cutting die assembly 13.

During the movement of the flat cutting die assembly 13 in covering the sheet 1, and once the vacuum cups 15 have secured the sheet 1 to the flat cutting die assembly 13, in a first pass of the flat cutting die assembly 13 over the sheet 1 has first set of eight beads of cold liquid adhesive is applied to each sheet 1 by the cold glue bead applicators 17 during the forward motion of the flat cutting die assembly 13 over the sheet 1. In doing so, the adhesive is, preferably, applied to a first sheet on every fourth scored area on the sheet, which is where the foldable region of the sheet is created. In this manner, the adhesive will be applied on the first scored/fold area, then on the fifth scored/fold are, then on the ninth scored/fold area, and so on.

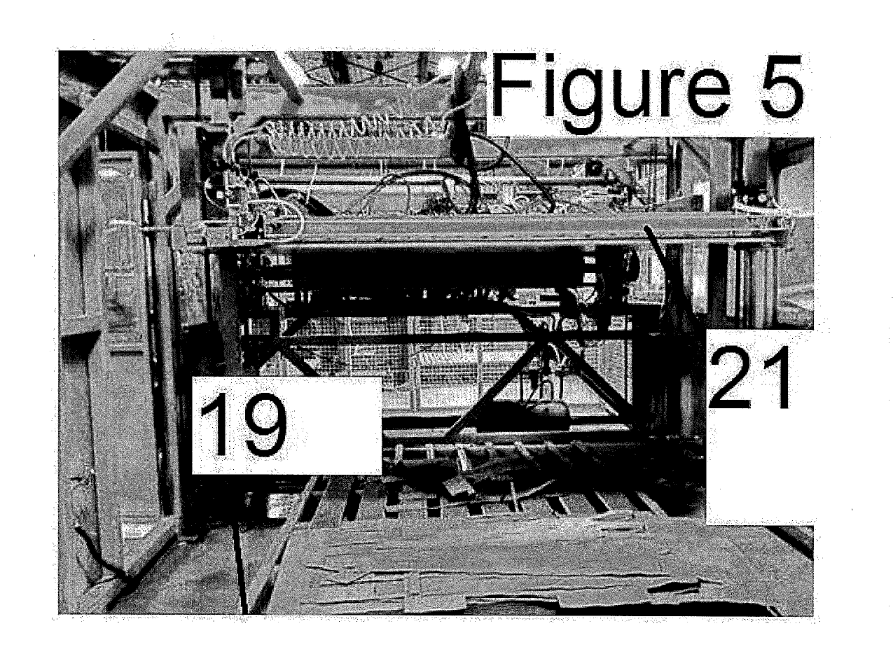

The sheet 1 that has been cut out and held in place by vacuum cups 15 on the flat cutting die assembly 13 is then ejected, as noted previously, from the flat cutting die assembly 13 through the vacuum means 7 reversing the venturi action of the vacuum cups 15, and the sheets are precisely piled into a straight stack onto an accumulating platform 19, as shown in FIG. 5. In the return movement of the cutting die 13 over the sheet 1 dropped onto the accumulating platform 19, as it returns to its operative position, another second set of eight beads of adhesive is then applied by the cold glue bead applicators 17 to the last sheet 1 dropped onto to the accumulating platform 19 and so on. In a preferred embodiment, the cold glue bead applicators 17 are indexed to four different positions on the flat cutting die assembly 13 in order to apply the sixteen beads of adhesive in total per sheet (in two passes of the cutting die 13 over the sheet 1), and the adhesive is applied at offset positions to that applied on the previous sheet laid down on the accumulating platform 19. As noted previously, the adhesive is applied on the first scored/fold area, then on the fifth scored/fold area, then on the ninth scored/fold area, and so on. Once a second sheet has adhesive applied to it, the adhesive is applied at an offset position, preferably two positions offset. In this manner, the adhesive is applied on the second sheet to a third scored/fold area, then on the seventh scored/fold area, then on the eleventh scored/fold area, and so on. Subsequent adhesive applied to further sheets will revert back to the above-noted pattern set out for alternating the application of adhesive to the first and second sheet.

It will, of course, be understood that the positioning of the cold glue bead applicators 17 on the flat cutting die assembly 13 could be varied. As sheets are dropped onto the accumulating platform 19, the accumulating platform lowers by the thickness of a sheet each and every time another sheet is placed on the accumulating platform 19.

Once a requisite number of sheets have been accumulated, the accumulating platform 19 is lowered onto a transfer conveyor (not shown) that moves the stack of accumulated sheets under a compression deck 21 hat compresses the stack to achieve a bond, the compression deck 21 being shown in an uncompressed state in FIG. 5 and during compression of the stack in FIG. 6. It will be understood that the requisite number of sheets accumulated before compression by the compression deck 21 will depend upon the open time of the adhesive so applied by the cold glue bead applicators 17, as the open time allows for the stacking of a number of sheets without forming a film. The compression deck 21 serves for compression of the bundle of stacked sheets that have been cut out to the desired pattern and glued at the proper intervals to further create a hexagon when expanded, as hereinafter described.

With reference to FIG. 6, the stack of sheets is then positioned under a nozzle 23 that further applies a hot melt, pressure sensitive adhesive in proper increments which match the cold liquid adhesive pattern previously laid by the cold glue bead applicators 17 inside the stack. More specifically, in a preferred embodiment, the hot melt, pressure sensitive adhesive is positioned so as to substantially correspond to a positioning of the cold adhesive applied to the second sheet (as previously described), in order to further bond the sections to one another to create a continuous cell pattern. These beads of hot melt, pressure sensitive adhesive are, preferably, applied at one inch increments as the transfer conveyor moves the stack one inch at a time, though it will be understood that this could be varied. In a preferred embodiment, the third application of adhesive is positioned so as to substantially correspond to a positioning of the second last sheet application pattern of adhesive in order to allow in the second section of the machine, subsequent bonding of the individual stacks of cut out sheet to one another in order to create a continuous feed of sheets.

Once the hot melt, pressure sensitive adhesive has been applied, a suitable protective cover, such as a release paper (not shown) is then applied to the areas on the top surface of the cell where the hot melt adhesive has been applied.

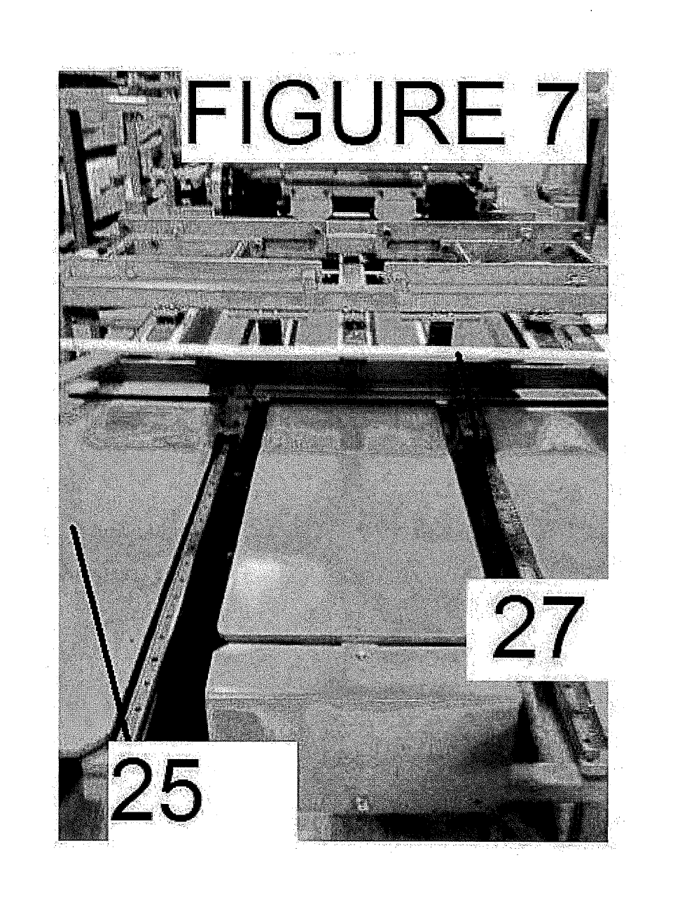

The bundle of sheets which have bean laminated together are then evacuated to a pressing table 25, shown in FIG. 7, which is where the operator lays end to end the individual blocks of pre-cut laminated sheets to further form a continuous strip of cell. The pressing/guiding mechanism 27 is used to further compress the stack of sheets.

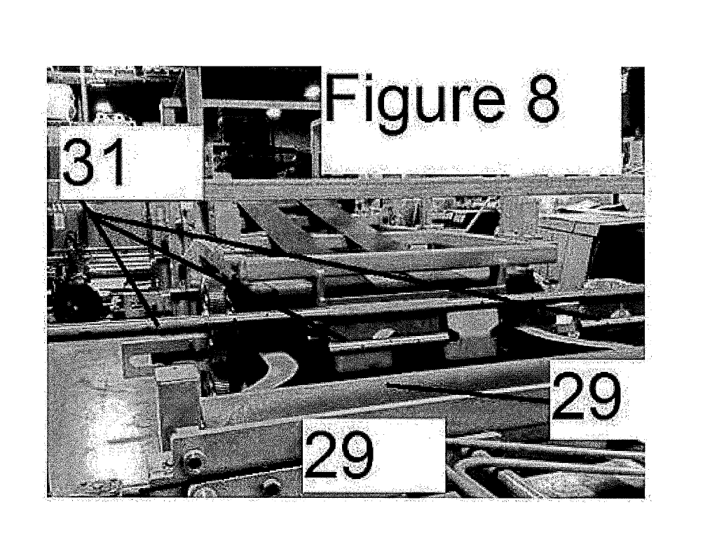

With reference to FIG. 8, motorized grip rollers 29 maintain the stack of strips in place while being pressed together ay pressing/guiding mechanism 27 to apply a pressure between the blocks of strips to form a continuous feed of cell on which a cold liquid adhesive is then applied to the upper and lower face of the cell, as hereinafter described. Once the pressing process has been finalized by pressing/guiding mechanism 27, the motorized grip rollers 29 are then engaged to feed the unexpanded strips forming the cell through cold adhesive applicators 31, shown in FIG. 8. The cold adhesive applicators 31 then spread cold adhesive onto the edges of the top and bottom of the stack of strips, which is fed slowly through the cold adhesive applicators 31 by the motorized grip rollers 29, the cold adhesive being applied on both top and bottom edges of the unexpanded strips later forming the cell.

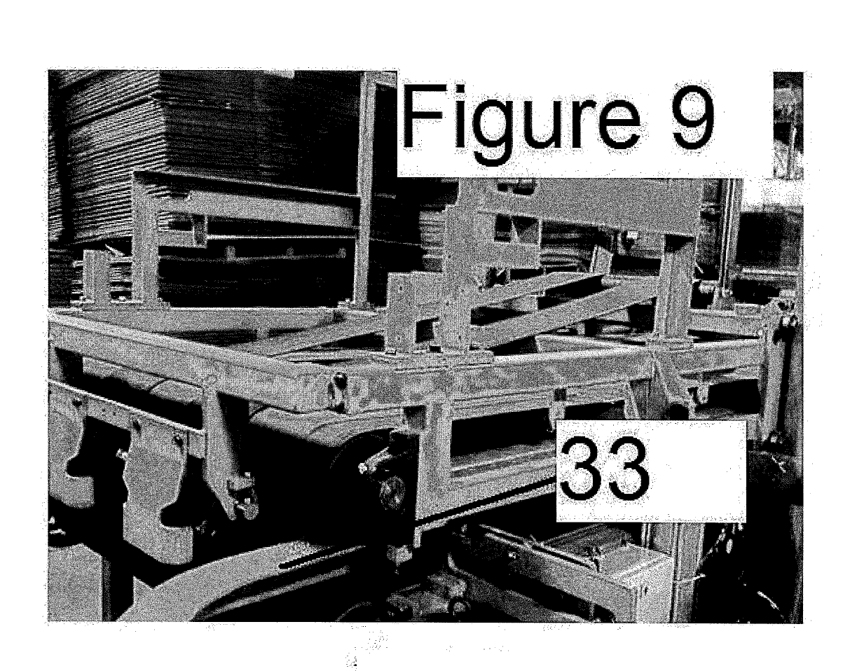

Once the adhesive is fully applied by said adhesive applicators 31 onto the top and bottom of the cell, the motorized grip rollers 29 continue to move the unexpanded sheets forming the cell to (see FIG. 9) lateral guides 33 that are utilized to force and expand the cell into a hexagonal shape structure. The motorized grip rollers 29 are synchronized to the proper ratio with the speed of the conveyer belt compression deck that also acts as a drive to pull on the laminated strips to expand them to a hexagonal cell. As the conveyor belt compression deck stretches the strips to a hexagonal cell, web fed paper liners are pulled along and laminated to the top and bottom surfaces of the expanded cell to form a continuous pallet. Speed of the compression deck conveyor is adjusted to the time required to achieve a bond between the expanded cell and the liners. Upon exit from the compression conveyor, the continuous length of pallet can then be cut to a desired length using, for example, a cross cut circular saw. The pallet is at this stage completed.

The unfolded cell structures, which will be used to form shipping pallets, can then be shipped in its folded state to maximize the number of pallets shipped in a transport trailer and to reduce the space required to store the pallets at the end user's or distributor's facility. At site, the unfolded cell structures can then have the release paper removed, and then be laminated on the areas having the cold adhesive with paper liner. Alternatively, paper tubes or other materials, such as wood dowels, can be inserted within the cell walls in an aligned manner at time of manufacturing for this given purpose. It will also be understood that the unfolded cell structures can be laminated on top and bottom with paper liner at the manufacturing facility, in addition to application at the end user's or distributor's facility. Compression of this paper liner can be provided by a compression deck conveyor that also serves to cure the adhesive until a bond is achieved. Upon exit from the compression conveyor, the continuous length of pallet can then be cut to a desired length using, for example, a circular razor saw, and then unfolded and stretched to form the completed shipping pallet. Once the shipping pallet has been expanded, and covered on top and bottom with the paper liner, it thereby becomes a strong, force resistant rectangular single pallet. Once the panel is dry, it can then be used for the shipment of goods.

Other embodiments consistent with the present invention will become apparent from consideration of the specification and the practice of the invention disclosed therein.

Accordingly, the specification and the embodiments are to be considered exemplary only, with the true scope and spirit of the invention being disclosed by the following claims.

The embodiments of the invention in which an exclusive property or privilege is claimed are defined as follows:

1. A method of forming an unfolded cellular pallet structure from sheets of fiberboard or paperboard material comprising:
loading sheets of the fiberboard or paperboard material into a die cutting assembly;
scoring each of the sheets, the scoring being effected in pairs on each alternating sheet of material, whereby a first score on a first sheet is scored facing upwardly, and another first score on a second sheet is scored facing downwardly, to provide a pattern;
applying a first application of adhesive to each of the sheets;
applying a second application of adhesive to each of the sheets, the second application of adhesive being applied at offset positions to the first application of adhesive on alternating sheets;
compressing the sheets to facilitate bonding of the adhesive to the sheets;
applying a third application of adhesive on the sheets, the third application of adhesive being positioned so as to substantially correspond to a positioning of the first application of adhesive.

2. A method of manufacturing an unfolded cellular pallet structure from sheets of fiberboard or paperboard material comprising:
loading sheets of the fiberboard or paperboard material into a die cutting assembly;
scoring each of the sheets between a pair of rotating gears, the scoring being effected in pairs on each alternating sheet of material, whereby a first score on a first sheet is scored facing upwardly, and another first score on a second sheet is scored facing downwardly, to provide a hexagonal pattern;
applying a first application of adhesive to each of the sheets;
applying a second application of adhesive to each of the sheets, the second application of adhesive being applied at offset positions to the first application of adhesive on alternating sheets;
compressing the sheets to facilitate bonding of the adhesive to the sheets;
applying a third application of adhesive on the sheets, the third application of adhesive being positioned so as to substantially correspond to a positioning of the first application of adhesive;
applying pressure sensitive adhesive to top and bottom surfaces of the unexpanded sheets;
covering the top and bottom surfaces of the unexpanded sheets with a release paper.

3. A method of manufacturing an unfolded cellular pallet structure from sheets of fiberboard or paperboard material comprising:
loading sheets of the fiberboard or paperboard material into a die cutting assembly;
scoring each of the sheets between a pair of rotating gears, the scoring being effected in pairs on each alternating sheet of material, whereby a first score on a first sheet is scored facing upwardly, and another first score on a second sheet is scored facing downwardly, to provide a hexagonal pattern;
applying suction to the sheets to permit connection to a flat cut die of the die cutting assembly;
applying a first application of adhesive to each of the sheets;
applying a second application of adhesive to each of the sheets, the second application of adhesive being applied at offset positions to the first application of adhesive on alternating sheets;
compressing the sheets to facilitate bonding of the adhesive to the sheets;
applying a third application of adhesive on the sheets, the third application of adhesive being positioned so as to substantially correspond to a positioning of the first application of adhesive and the second application of adhesive;
applying cold adhesive to top and bottom surfaces of the unexpanded sheets;
expanding cells of the unfolded cellular pallet structure into shaped cells between 25 and mm width;
covering the top and bottom surfaces of the unexpanded sheets with a release paper.

4. The method of any one of claims 1 to 3, further comprising the step of shipping the unfolded cellular pallet structure to a remote facility for later unfolding of the pallet structure.

5. The method of any one of claims 1 or 2, wherein the step of scoring each of the sheets further comprises feeding the sheets through a set of driven rotating gears.

6. The method of any one of claims 1 to 3, wherein the steps of applying the adhesive further comprises utilizing a sprayer to apply the adhesive on the sheets.

7. The method of any one of claims 1 to 3, wherein the steps of applying the adhesive further comprises utilizing cold glue bead applicators to apply the adhesive on the sheets.

8. The method of claim 1 or 2, wherein the step of compressing the sheets further comprises utilizing suction cups positioned on the die cut assembly to apply suction to permit connection to the die cut assembly.

9. The method of claim 3, wherein the step of applying suction to the sheets further comprises utilizing suction cups positioned on the flat cut die to apply suction to permit connection to the flat cut die.

10. A method of manufacturing an unfolded cellular pallet structure from sheets of fiberboard or paperboard material comprising:
loading sheets of the fiberboard or paperboard material into a die cutting assembly;
scoring each of the sheets between a pair of rotating gears, the scoring being effected in pairs on each alternating sheet of material, whereby a first score on a first sheet is scored facing upwardly, and another first score on a second sheet is scored facing downwardly, to provide a hexagonal pattern;
applying suction to the sheets to permit connection to a flat cut die of the die cutting assembly;
applying a first application of adhesive to a first one of the sheets;
ejecting the first one of the sheets onto an accumulating platform;
applying a second application of adhesive to the first one of the sheets;
ejecting at least a second one of the sheets onto an accumulating platform;
applying a first application of adhesive to the at least a second one of the sheets;
ejecting the at least a second one of the sheets;
applying a second application of adhesive to the at least a second one of the sheets, the second application of adhesive being applied at offset positions to the first application of adhesive applied on the first one of the sheets, and so forth;
compressing the sheets to facilitate bonding of the adhesive to the sheets;
applying cold adhesive to top and bottom surfaces of the unexpanded sheets;
expanding cells of the unfolded cellular pallet structure into shaped cells between 25 and mm width;
covering the top and bottom surfaces of the unexpanded sheets with a release paper.

11. The method of claim 10, wherein, when a third sheet has adhesive applied to it, the adhesive is positioned so as to substantially correspond to a positioning of the first application of adhesive and the second application of adhesive on the first one of the sheets.

12. The method of claim 10, wherein, when a fourth sheet has adhesive applied to it, the adhesive is positioned so as to substantially correspond to a positioning of the first application of adhesive and the second application of adhesive on the second one of the sheets.

13. An apparatus for manufacturing an unfolded cellular pallet structure from sheets of fiberboard or paperboard material comprising:
a feeder for feeding the sheets into the apparatus;
a pair of rotating gears for receiving the sheets from the feeder and scoring each of the sheets therebetween;
a flat cutting die assembly for receiving the sheets from the pair of rotating gears;
vacuum means positioned on the flat cutting die assembly for applying suction to the sheets to permit connection to the flat cutting die assembly;
an adhesive applicator positioned on the flat cutting die assembly for applying adhesive to each of the sheets; and
a compression deck for compressing each of the sheets to facilitate bonding of the adhesive to the sheets.

14. The apparatus of claim 13, wherein the feeder further comprises a covered roller.

15. The apparatus of claim 13, wherein the pair of rotating gears effect the scoring on each of the sheets therebetween, the scoring being effected in pairs on each alternating sheet of material, whereby a first score on a first sheet is scored facing upwardly, and another first score on a second sheet is scored facing downwardly, to provide a hexagonal pattern.

16. The apparatus of claim 13, wherein an elevating platform is used for transferring the scored sheets from the pair of rotating gears to the flat cutting die assembly.

17. The apparatus of claim 13, wherein the vacuum means are suction cups.

18. The apparatus of claim 13, wherein the flat cutting die assembly further comprises cutting knives on a lower surface thereof, whereby, when the sheets are compressed by the pair of rollers, the cutting knives cut the sheets.

19. The apparatus of claim 13, wherein the adhesive applicator applies a plurality of beads of cold liquid adhesive in two different positions on each sheet.

20. The apparatus of claim 13, wherein the adhesive applicator applies sixteen beads of cold liquid adhesive in two different positions on each sheet.

21. The apparatus of claim 13, wherein the adhesive applicator is a plurality of cold glue bead applicators.

22. The apparatus of claim 21, wherein the plurality of cold glue bead applicators are positioned at four different positions on the flat cutting die assembly.

23. The apparatus of claim 18, wherein the apparatus further comprises an accumulating platform.

24. The apparatus of claim 23, wherein the apparatus further comprises ejection means for ejecting the cut sheets from the flat cutting die assembly onto the accumulating platform to form a stack of sheets.

25. The apparatus of claim 24, wherein the apparatus further comprises a hot melt nozzle for applying a hot melt adhesive to the stack of sheets.

26. The apparatus of claim 25, wherein the apparatus further comprises covering means for covering top and bottom surfaces of the stack of sheets with a release paper.

27. The apparatus of claim 26, wherein the apparatus further comprises at least a pair of gripping rollers for holding the stack of sheets in place and for compressing the stack of sheets.

28. The apparatus of claim 26, wherein the apparatus further comprises at least a pair of lateral guides for expanding the stack of sheets into an expanded cell.

29. The apparatus of claim 28, wherein the at least a pair of lateral guides expanding the stack of sheets into a hexagonal cell structure.

30. The apparatus of claim 28, wherein the apparatus further comprises a cold adhesive applicator for applying cold adhesive to top and bottom surfaces of the expanded cell.

31. The apparatus of claim 30, wherein the apparatus further comprises laminating means for applying a paper liner to the top and bottom surfaces of the expanded cell.
